(19) United States
(12) Patent Application Publication
(10) Pub. No.: US 2017/0237269 A1
(43) Pub. Date: Aug. 17, 2017

(54) BATTERY CHARGE-DISCHARGE BALANCING CIRCUIT ASSEMBLY

(71) Applicant: CHANGS ASCENDING ENTERPRISE CO., LTD., TAICHUNG CITY (TW)

(72) Inventors: Tsun-Yu CHANG, TAICHUNG CITY (TW); Chun-Chieh CHANG, TAICHUNG CITY (TW); Yu-Ta TSENG, TAICHUNG CITY (TW)

(21) Appl. No.: 14/907,845

(22) PCT Filed: Sep. 30, 2015
(86) PCT No.: PCT/CN2015/091155

§ 371 Date: Jan. 27, 2016

(51) Int. Cl. H02J 7/00

(52) U.S. Cl. CPC H02J 7/0016; H02J 7/0021

(57) ABSTRACT

A battery charge-discharge balancing circuit assembly used in a battery pack consisting of multiple secondary battery cells is disclosed to include a switch device installed in each of the positive and negative terminals of each secondary battery cell and a balancing resistor connected with all the secondary battery cells in a parallel manner and the balancing resistor device having two opposite ends thereof connected the switch devices in series. All the secondary battery cells or multiple secondary battery cells of the battery pack can share one balancing resistor. By means of discharging the secondary battery cells in rotation, every secondary battery cell gets balanced to achieve efficient charging, eliminating the problem of overheat of the prior art technique.

### BACKGROUND OF THE INVENTION

1. Field of the Invention

The present invention relates to battery charge-discharge balancing technology and more particularly, to a battery charge-discharge balancing assembly for use in a battery pack consisting of a series of secondary battery cells to balance the cells charge.

2. Description of the Related Art

With the development of electronic technology, consumer electronics products such as cell phone, computer, electric car, etc. already are indispensable and important for modern people. In order to extend the use of time and performance of these electronic products, the battery packs of these electronic products generally consist of a plurality of battery cells that are connected in series. Typically, the individual battery cells in a battery pack have somewhat different capacities and may be at different levels of state of charge. Without redistribution, some particular battery cells can be overcharged or undercharged, shortening the lifespan of the entire battery pack or affecting the use of the battery pack, or even endangering the safety of the battery pack.

When charging two secondary battery cells in a series that have a significant capacity difference (over 10%), the secondary battery cell that has a relatively lower capacity will reach the saturated status at first and the voltage of this secondary battery cell of relatively lower capacity will keep increasing, leading to irreversible secondary battery cell damage, or even fire and explosion. Accordingly, the current practice is to connect an overcharge safety circuit to the secondary battery cells in a parallel manner for secondary battery cell charging protection.

In order to eliminate the problem of uneven charging of battery cells that are connected in series in a battery pack, various battery charging or discharging balancing techniques have been disclosed. In the technique of series connection of shunt resistor, as illustrated in FIG. 1, multiple secondary battery cells 11 are connected with the positive terminal of one secondary battery cell to the negative terminal of another in series to constitute a battery pack that is dischargeable by a DC charger 10; each secondary battery cell 11 is connected in parallel to an overcharge circuit 20 consisting of a switch device 21 and a resistor 22 that are connected in series. A battery monitoring system (not shown) detects the voltage of every individual secondary battery cell, and controls “opening” and “closing” of the associating switch device 21 subject to the detection. If the voltage at the two opposite ends of one secondary battery cell 11 is larger than or equal to a predetermined voltage value, the respective the overcharge circuit 20 is controlled to discharge charges, achieving protection to the series of secondary battery cells 11.

However, arranging one respective resistor 22 at each secondary battery cell 11 greatly increase the cost. Further, when multiple resistors 22 are driven to discharge charges, the entire battery pack will become very hot. Further, the resistors 22 can get damaged easily if the secondary battery cells 11 are frequently overcharged, shortening the lifespan of the battery pack.

### SUMMARY OF THE INVENTION

The present invention has been accomplished under the circumstances in view. It is the main object of the present invention to provide a battery charge-discharge balancing circuit assembly, which uses one single resistor or a limited number of resistors to achieve cell balancing, improving the charging performance and eliminating the problem of overheat of the prior art balancing technique due to the arrangement of a large number of resistors.

It is another object of the present invention to provide a battery charge-discharge balancing circuit assembly, which provides a balancing resistor device design for enabling multiple resistors to work in rotation for discharge control, thereby shortening the discharging time of each resistor in the battery pack and reducing the risk of destruction of the cell-balancing performance and entire battery pack damage upon failure of one single resistor.

To achieve these and other objects of the present invention, a battery charge-discharge balancing circuit assembly is used in a battery pack consisting of multiple secondary battery cells that are connected in series and chargeable by a DC charger. The battery charge-discharge balancing circuit assembly comprises a switch device installed in each of the positive and negative terminals of each secondary battery cell, and a balancing resistor device connected with all secondary battery cells in a parallel manner and having two opposite ends thereof connected with the switch devices in series, wherein one common switch device is installed in the junction between each two adjacent secondary battery cells.

In one embodiment of the present invention, the balancing resistor device consists of a plurality of resistors connected in parallel.

Further, the resistors of the balancing resistor device are connected in series to one switch device, and operated in rotation for discharge control/

In another embodiment of the present invention, each secondary battery cell is made in the form of a battery pack consisting of a plurality of multiple sub secondary battery cells that are connected in series with one respective switch device installed in each of the positive and negative terminals of each sub secondary battery cell and one respective balancing resistor device connected with all sub secondary battery cells in a parallel manner

In still another embodiment of the present invention, the battery charge-discharge balancing circuit assembly is used in a battery pack consisting of multiple secondary battery cells that are connected in series and chargeable by a DC charger, wherein all the secondary battery cells in the battery pack are evenly divided into multiple battery sections. The battery charge-discharge balancing circuit assembly in this embodiment comprises a switch device installed in each of the positive and negative terminals of each secondary battery cell in each battery pack section, and a balancing resistor device installed in each battery pack section and connected with all secondary battery cells in the respective battery pack section in a parallel manner, wherein the balancing resistor device has two opposite ends thereof connected with the switch devices in the respective battery pack section in series; one common switch device is installed in the junction between each two adjacent secondary battery cells in each battery pack section.

Preferably, the balancing resistor device in this embodiment consists of a plurality of resistors connected in parallel, and the resistors of each balancing resistor device are connected in series to one switch device.

Preferably, each secondary battery cell in this embodiment is made in the form of a battery pack consisting of a plurality of multiple sub secondary battery cells that are connected in series with one respective said switch device installed in each of the positive and negative terminals of each sub secondary battery cell and one respective balancing resistor device connected with all sub secondary battery cells in a parallel manner.

By means of alternating the circuit design to let every secondary battery cell shares one common balancing resistor device, or multiple secondary battery cells in the battery pack share one common balancing resistor device, cell balancing is achieved to improve the charging performance, eliminating the problem of overheat of the prior art balancing technique due to the arrangement of a large number of resistors. Further, through the design of the balancing resistor device and the design that enables the resistors of the balancing resistor device to work in rotation for discharge control, the invention greatly shortens the discharging time of each resistor in the battery pack, reducing the risk of destruction of the cell-balancing performance and entire battery pack damage upon failure of one single resistor and prolonging the lifespan of the battery pack.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic circuit block diagram of a battery charge-discharge balancing circuit assembly according to the prior art.

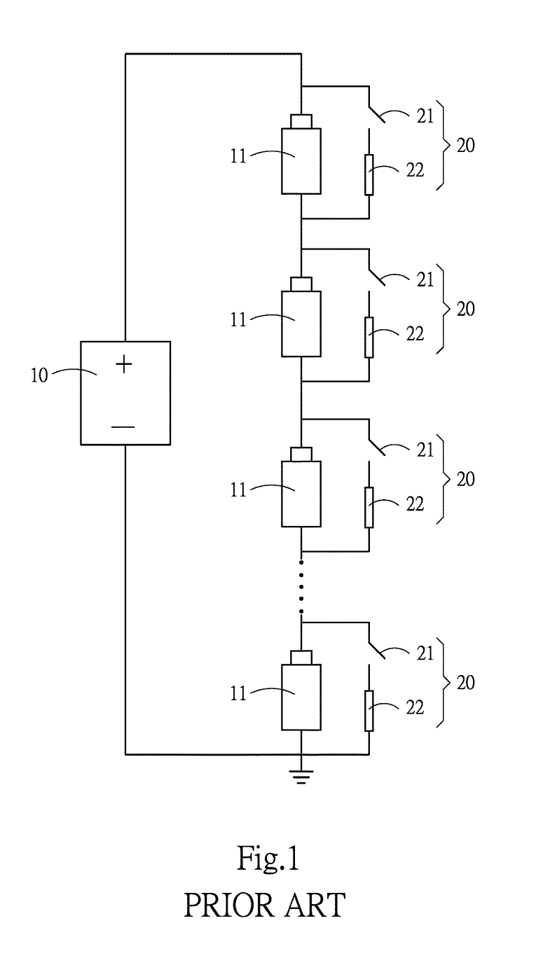

FIG. 2 is a schematic circuit block diagram of a battery charge-discharge balancing circuit assembly in accordance with the present invention (I).

FIG. 3 is a schematic circuit block diagram of a battery charge-discharge balancing circuit assembly in accordance with the present invention (II).

FIG. 4 is a schematic circuit block diagram of a battery charge-discharge balancing circuit in accordance with the present invention (III).

FIG. 5 is a schematic circuit block diagram of a battery charge-discharge balancing circuit assembly in accordance with the present invention (IV).

FIG. 6 is a schematic circuit block diagram of a battery charge-discharge balancing circuit assembly in accordance with the present invention (V).

FIG. 7 is a schematic circuit block diagram of a battery charge-discharge balancing circuit assembly in accordance with the present invention (VI).

FIG. 8 is a schematic circuit block diagram of a battery charge-discharge balancing circuit assembly in accordance with the present invention (VII).

FIG. 9 is a schematic circuit block diagram of a battery charge-discharge balancing circuit assembly in accordance with the present invention (VIII).

FIG. 10 is a schematic circuit block diagram of a battery charge-discharge balancing circuit assembly in accordance with the present invention (IX).

### DETAILED DESCRIPTION OF THE INVENTION

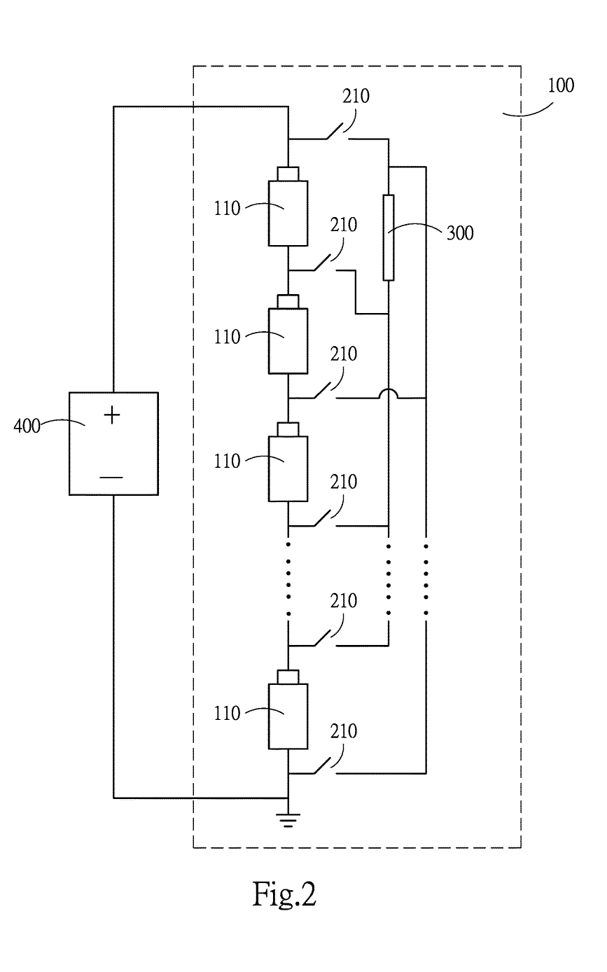

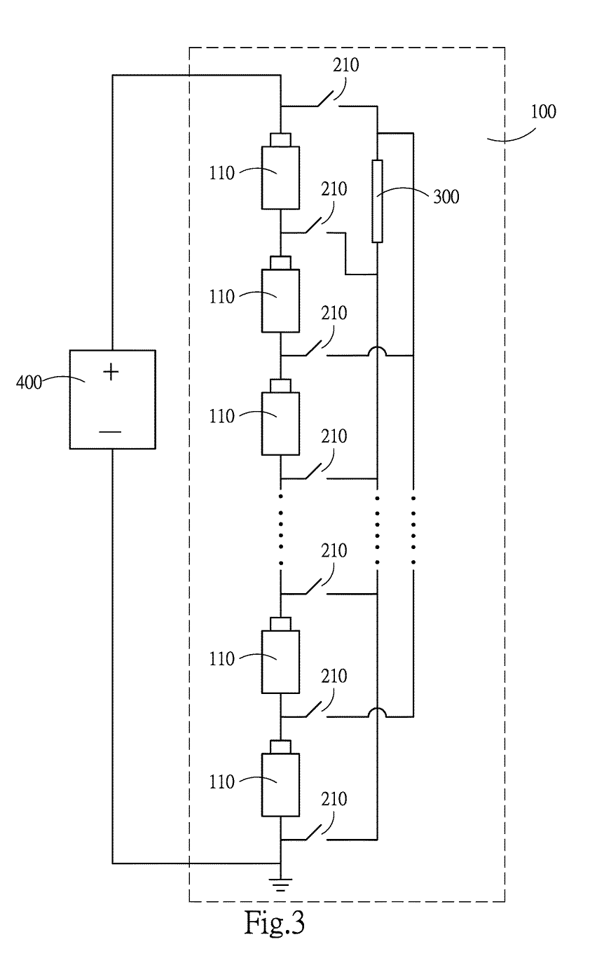

Referring to FIGS. 2 and 3, a battery charge-discharge balancing circuit assembly of the present invention is used in a battery pack 100 consisting of multiple secondary battery cells 110 that are connected with the positive terminal of one secondary battery cell to the negative terminal of another in series. The battery pack 100 can be charged by a DC charger 400. The invention is characterized in that: the battery charge-discharge balancing circuit assembly comprises a switch device 210 installed in each of the positive and negative terminals of each individual secondary battery cell 110 of the battery pack 100, and a balancing resistor device 300 connected with all the secondary battery cells 110 in a parallel manner and having two opposite ends thereof connected with the switch devices 210 in series, wherein one common switch device 210 is used in the unction between each two adjacent secondary battery cells 110.

In the embodiment shown in FIG. 2, the battery pack 100 of the battery charge-discharge balancing circuit assembly consists of an even number of secondary battery cells 110. In the embodiment shown in FIG. 3, the battery pack 100 of the battery charge-discharge balancing circuit assembly consists of an odd number of secondary battery cells 110.

In application, a battery monitoring system (not shown) scans the voltage of every individual secondary battery cell 110 during the charge operation, and controls “opening” and “closing” of the switch devices 21 at the positive and negative terminals of every secondary battery cells 110 to discharge charges by way of rotation, i.e., when the voltage at the two opposite ends of one secondary battery cell 110 is scanned higher than or equal to a predetermined voltage value, this secondary battery cell 110 will be controlled by the balancing resistor device 300 to discharge charges, thereby achieving protection to the series of secondary battery cells 110. In case that the voltages at the two opposite ends of multiple secondary battery cells 110 are scanned higher than or equal to the predetermined voltage value, these secondary battery cell 110 will be controlled by the balancing resistor device 300 to discharge charges by way of rotation after every voltage scan cycle.

Through a change in the circuit design, every secondary battery cell 110 of the battery pack 100 shares the common balancing resistor device 300 to achieve charge/discharge balancing across the secondary battery cells 110, so that balancing performance can be obtained for every secondary battery cell 110 of the battery pack 100, eliminating the problem of overheat due to excessive resistance as seen in the prior art cell-balancing techniques.

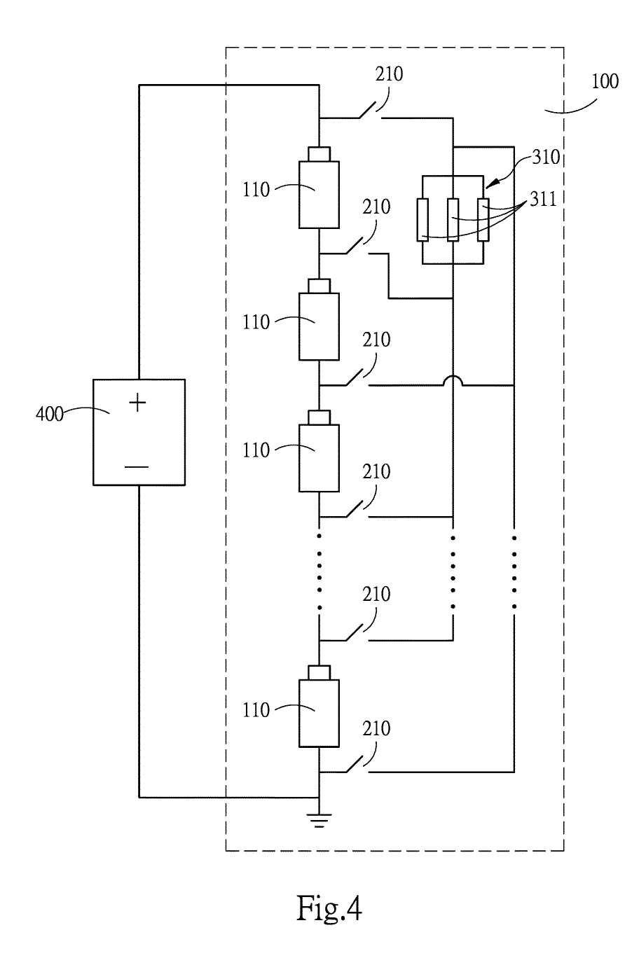

Referring to FIG. 4, in an alternate form of the present invention, a balancing resistor device 310 consisting of a plurality of (for example, 3) resistors 311 is used to substitute for the aforesaid balancing resistor device 300. The charge discharging operation of this embodiment is same as above-described embodiment of FIGS. 2 and 3, however, because the balancing resistor device 310 of this alternate form consists of a plurality of resistors 311 that are connected in parallel, this alternate form reduces the risk of destruction of the cell-balancing performance and entire battery pack damage upon failure of one single resistor.

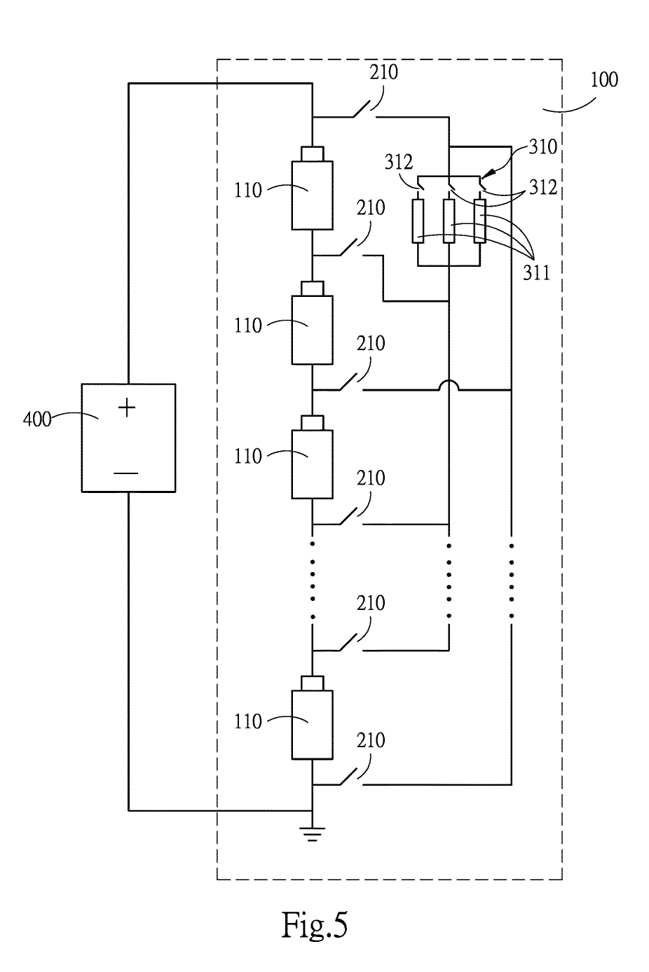

Referring to FIG. 5, in another alternate form of the present invention, a switch device 312 is connected in series to every resistor 311 of the balancing resistor device 310. The charge discharging operation of this embodiment is same as embodiment of FIG. 4, however, because all of the switch devices 312 are controlled by the battery monitoring system (not shown), when driving the secondary battery cells 110 to discharge in rotation, the “opening” or “closing” status of the switch devices 312 controls the resistors 311 of the balancing resistor device 310 to work in rotation for the function of discharge. In application, this embodiment reduces the risk of destruction of the cell-balancing performance and entire battery pack damage upon failure of one single resistor.

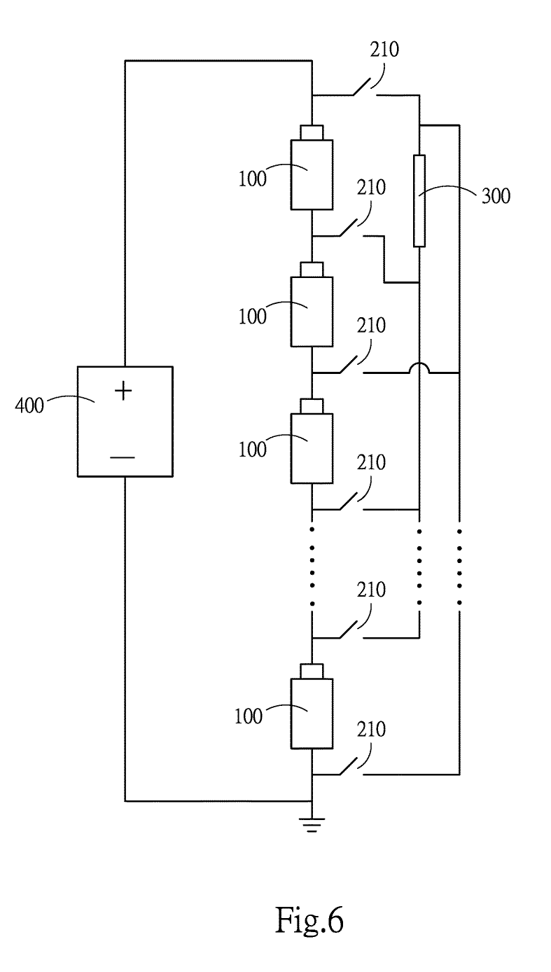

Referring to FIG. 6, in still another alternate form of the present invention, a battery pack 100 is used to substitute for each secondary battery cell 110, and the battery charge-discharge balancing circuit assembly is used in each of a series of battery packs 100. In this embodiment, the series of battery packs 100 consists of an even number of battery packs 100; each battery pack 100 consists of an even number of secondary battery cells 110 that are connected with the positive terminal of one secondary battery cell to the negative terminal of another in series (see also FIG. 2). Thus, in this embodiment, an even number of battery packs 100 are assembled into a big scale battery pack assembly having multiple layers of battery charge-discharge balancing circuits built therein.

This embodiment runs the same charging and discharging operation. In the charging phase, the battery monitoring system (not shown) scans the voltage of every individual battery pack 100, and controls “opening” and “closing” of the switch devices 21 at the positive and negative terminals of every battery pack 100 to discharge charges by way of rotation, i.e., when the voltage at the two opposite ends of one battery pack 100 is scanned higher than or equal to a predetermined voltage value, this battery pack 100 will be controlled by the balancing resistor device 300 to discharge charges, thereby achieving protection to the series of battery pack 100. In case that the voltages at the two opposite ends of multiple battery packs 100 are scanned higher than or equal to the predetermined voltage value, these battery packs 100 will be controlled by the balancing resistor device 300 to discharge charges by way of rotation after every voltage scan cycle.

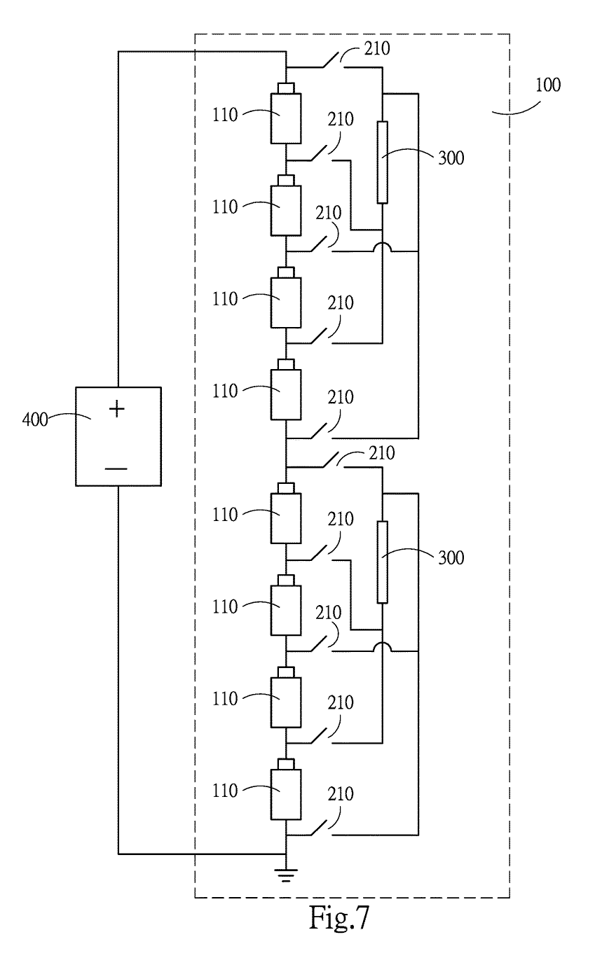

Referring to FIG. 7, in still another alternate form of the present invention, multiple secondary battery cells 110 within the battery pack 100 are evenly divided into multiple battery pack sections wherein the secondary battery cells 110 in each battery pack section share one common balancing resistor device 300; a switch device 210 installed in each of the positive and negative terminals of each individual secondary battery cell 110 of each battery pack section; the secondary battery cells 110 in each battery pack section are connected in parallel to the respective common balancing resistor device 300; the switch devices 210 at the positive and negative terminals of each individual secondary battery cell 110 of each battery pack section are connected in series to the opposite ends of the respective common balancing resistor device 300.

Same as the above-described various embodiments, one common switch device 210 is used in the junction between each two adjacent secondary battery cells 110 in each battery pack section.

In the embodiment shown in FIG. 7, the battery pack 100 consists of 8 pcs of secondary battery cells 110 that are divided into two battery pack sections; the four secondary battery cells 110 in each battery pack section share one common balancing resistor device 300 for discharge control. Similar to the aforesaid various other alternate forms, when the voltage at the two opposite ends of one secondary battery cell 110 in one battery pack section is scanned higher than or equal to a predetermined voltage value, this secondary battery cell 110 will be controlled by the associating balancing resistor device 300 to discharge charges, thereby achieving protection to the series of secondary battery cells 110 in the respective battery pack section. In case that the voltages at the two opposite ends of multiple secondary battery cells 110 in one or multiple battery pack sections are scanned higher than or equal to the predetermined voltage value, the secondary battery cells 110 in each battery pack section will be controlled by the associating balancing resistor device 300 to discharge charges by way of rotation after every voltage scan cycle.

Actually, because the invention enables the secondary battery cells to discharge charges by way of rotation after every voltage scan cycle, every secondary battery cell 110 in the group of 4 pcs of secondary battery cells 110 can enter the discharge action more quickly than in the group of 8 pcs of secondary battery cells 110, and the discharging time can be relatively longer. More particularly, in a battery pack consisting of more than 10 pcs of secondary battery cells 110 for vehicle starter, electric bicycle, electric motorcycle, electric or hybrid car for high-voltage application, these secondary battery cells 110 need to be divided into multiple battery pack sections with one balancing resistor device 300 arranged in each pack section to improve the charging efficiency. By means of alternating the circuit design to let multiple secondary battery cells 110 in the battery pack share one common balancing resistor device 300, cell balancing is achieved to improve the charging performance, eliminating the problem of overheat of the prior art balancing technique due to the arrangement of a large number of resistors.

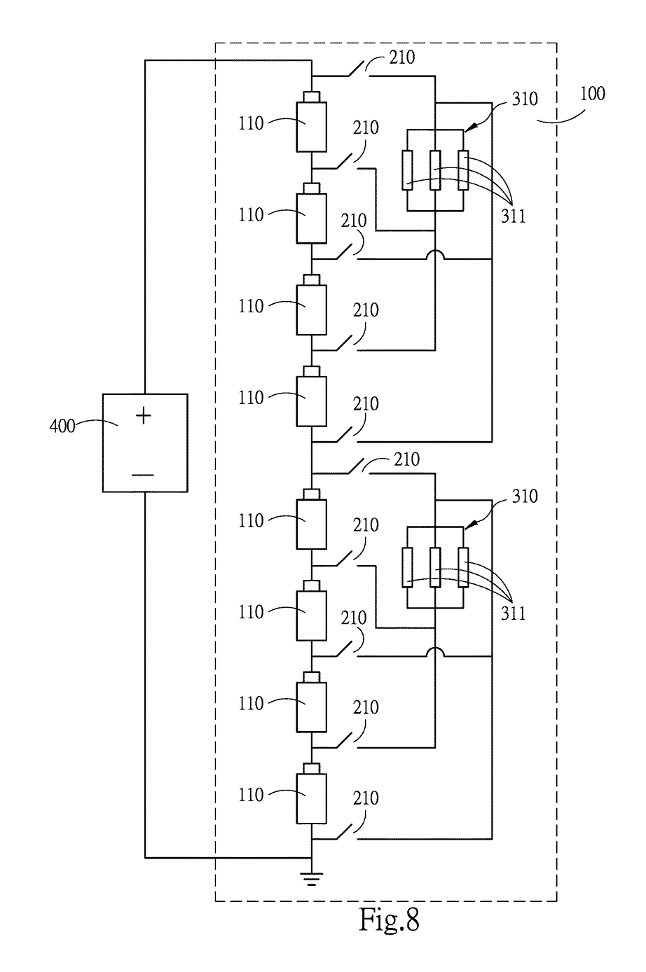

FIG. 8 illustrates still another alternate form of the present invention. This embodiment is substantially similar to that shown in FIG. 7 with the exception that each balancing resistor device 300 consists of a plurality of resistors 311 (for example, three resistors 311) that are connected in parallel. The discharging operation of this embodiment is same as that of FIG. 7, however, because each balancing resistor device 300 in this embodiment consists of a plurality of resistors 311, this embodiment lowers the risk of interference with battery pack balancing performance and battery pack damage due to damage of one single resistor.

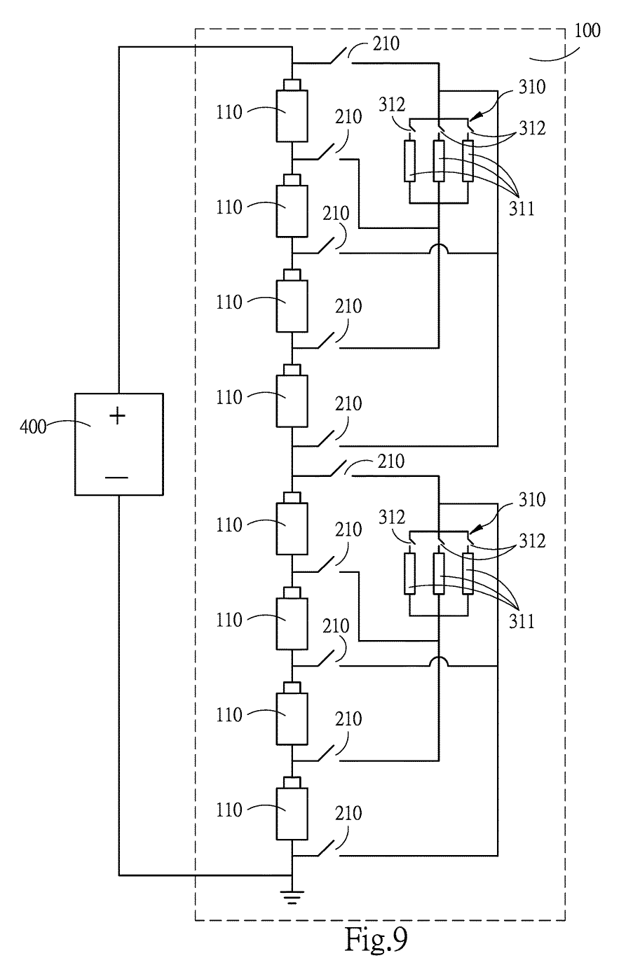

In the embodiment shown in FIG. 9, each resistor 311 of the balancing resistor device 310 has a switch device 312 connected thereto in series. The discharging operation of this embodiment is same as the various above-described other embodiments, however, in this embodiment, all the switch devices 312 controlled by the battery monitoring system (not shown). In the discharging phase, the battery monitoring system scans the voltage of every individual battery pack 100, and controls “opening” and “closing” of the switch devices 312 at the positive and negative terminals of every battery pack 100, controlling the resistors 311 of the balancing resistor device 310 for discharging charges by way of rotation, thus, this embodiment lowers the risk of interference with battery pack balancing performance and battery pack damage due to damage of one single resistor.

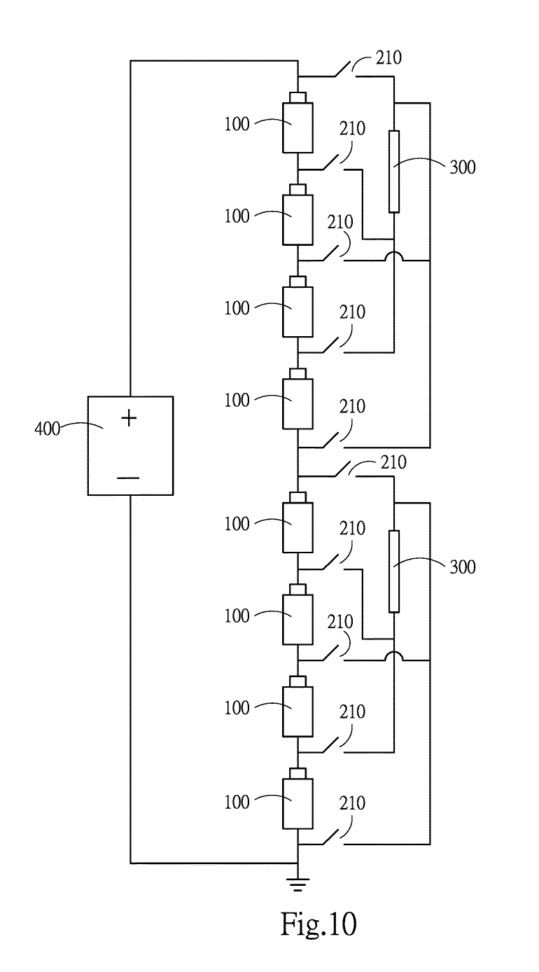

In the embodiment shown in FIG. 10, the battery charge-discharge balancing circuit assembly of the present invention is used in a series of battery packs 100 that are divided into multiple battery pack sections. In this embodiment, 8 pcs of battery packs 100 are arranged in two battery pack sections; the four secondary battery packs 110 in each battery pack section share one common balancing resistor device 300 for discharge control. Thus, in this embodiment, an even number of battery packs 100 are assembled into a big scale battery pack assembly having multiple layers of battery charge-discharge balancing circuits built therein.

By means of alternating the circuit design to let every secondary battery cell shares one common balancing resistor device, or multiple secondary battery cells in the battery pack share one common balancing resistor device, cell balancing is achieved to improve the charging performance, eliminating the problem of overheat of the prior art balancing technique due to the arrangement of a large number of resistors. Further, through the design of the balancing resistor device and the design that enables the resistors of the balancing resistor device to work in rotation for discharge control, the invention greatly shortens the discharging time of each resistor in the battery pack, reducing the risk of destruction of the cell-balancing performance and entire battery pack damage upon failure of one single resistor and prolonging the lifespan of the battery pack.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A battery charge-discharge balancing circuit assembly used in a battery pack consisting of multiple secondary battery cells that are connected in series and chargeable by a DC charger, wherein the battery charge-discharge balancing circuit assembly comprises a switch device installed in each of the positive and negative terminals of each said secondary battery cell and a balancing resistor device connected with all said secondary battery cells in a parallel manner, said balancing resistor device having two opposite ends thereof connected with said switch devices in series.

2. The battery charge-discharge balancing circuit assembly as claimed in claim 1, wherein one common said switch device is installed in the junction between each two adjacent said secondary battery cells.

3. The battery charge-discharge balancing circuit assembly as claimed in claim 1, wherein said balancing resistor device consists of a plurality of resistors connected in parallel.

4. The battery charge-discharge balancing circuit assembly as claimed in claim 3, wherein said resistors of said balancing resistor device are connected in series to one said switch device.

5. The battery charge-discharge balancing circuit assembly as claimed in claim 1, wherein each said secondary battery cell is made in the form of a battery pack consisting of a plurality of multiple sub secondary battery cells that are connected in series with one respective said switch device installed in each of the positive and negative terminals of each said sub secondary battery cell and one respective said balancing resistor device connected with all said sub secondary battery cells in a parallel manner.

6. A battery charge-discharge balancing circuit assembly used in a battery pack consisting of multiple secondary battery cells that are connected in series and chargeable by a DC charger, wherein all said secondary battery cells in said battery pack are evenly divided into multiple battery sections; the battery charge-discharge balancing circuit assembly comprises a switch device installed in each of the positive and negative terminals of each said secondary battery cell in each said battery pack section and a balancing resistor device installed in each said battery pack section and connected with all said secondary battery cells in the respective said battery pack section in a parallel manner, said balancing resistor device having two opposite ends thereof connected with said switch devices in the respective said battery pack section in series.

7. The battery charge-discharge balancing circuit assembly as claimed in claim 6, wherein one common said switch device is installed in the junction between each two adjacent said secondary battery cells in each said battery pack section.

8. The battery charge-discharge balancing circuit assembly as claimed in claim 6, wherein said balancing resistor device consists of a plurality of resistors connected in parallel.

9. The battery charge-discharge balancing circuit assembly as claimed in claim 8, wherein said resistors of each said balancing resistor device are connected in series to one said switch device.

10. The battery charge-discharge balancing circuit assembly as claimed in claim 6, wherein each said secondary battery cell is made in the form of a battery pack consisting of a plurality of multiple sub secondary battery cells that are connected in series with one respective said switch device installed in each of the positive and negative terminals of each said sub secondary battery cell and one respective said balancing resistor device connected with all said sub secondary battery cells in a parallel manner.
